(19) United States
(12) Patent Application Publication
(10) Pub. No.: US 2026/0287751 A1
(43) Pub. Date: Sep. 24, 2026

(54) METHOD AND DEVICE FOR IDENTIFYING A FAULTY SATELLITE AMONG A SET OF SATELLITES

(71) Applicant: SAFRAN ELECTRONICS & DEFENSE, Paris (FR)

(72) Inventors: Julien NGUYEN, Moissy-Cramayel (FR); Maxime NGUYEN, Moissy-Cramayel (FR); Loïc DAVAIN, Moissy-Cramayel (FR); Nathan FOUIN, Moissy-Cramayel (FR)

(73) Assignee: SAFRAN ELECTRONICS & DEFENSE, Paris (FR)

(21) Appl. No.: 19/474,160

(22) PCT Filed: Apr. 3, 2024
(86) PCT No.: PCT/FR2024/050429

§ 371 Date: Oct. 9, 2025

(30) Foreign Application Priority Data
Apr. 11, 2023 (FR) FR2303580

(51) Int. Cl. G01S 19/20

(52) U.S. Cl. CPC G01S 19/20

(57) ABSTRACT

A method and device for identifying a faulty satellite among a set of satellites S₁, . . . , S_{N} from pseudo-ranges between a mobile and the satellites S₁, . . . , S_{N}. Particularly, the method includes, following detection of a satellite failure, steps of: for each satellite Sᵢ of the set of satellites S₁, . . . , S_{N}: obtaining a set Pᵢ of positions of the mobile, each position p_{i,j} being determined from the pseudo-ranges associated with the satellites S₁, . . . , S_{N} by excluding: the satellite Sᵢ; and at least one other different satellite Sⱼ for each position p_{i,j}; determining a dispersion indicator al for the positions of the set Pᵢ; and identifying the faulty satellite among the set of satellites S₁, . . . S_{N} as a function of the dispersion indicators σ₁, . . . , σ_{N}.

### TECHNICAL FIELD

The present invention relates to the field of satellite navigation, also known as GNSS (Global Navigation Satellite System) navigation. Particularly, the present invention relates to a method and a device for identifying a faulty satellite among a set of satellites, as well as associated navigation system, aircraft and computer program. The present invention finds a particularly advantageous, although in no way limiting, application for the implementation of satellite navigation systems for aircrafts, ships or land vehicles.

### PRIOR ART

The invention falls within the specific context of satellite navigation systems. Embedded in a mobile machine (e.g., an aircraft), such a navigation system uses the signals received from satellites to determine the position of the mobile, and potentially other navigation data of the mobile such as its speed and orientation. To determine the position of a mobile, a satellite navigation system uses the positioning measurements, known as pseudo-ranges, provided by a GNSS receiver. These measurements characterize the distances between the mobile and the visible satellites in a constellation. Within the framework of the invention, the navigation systems considered may also use data derived from an inertial unit to determine the navigation data of the mobile by using for example a multi-sensor fusion algorithm based on a Kalman filter.

For some applications, such as aeronautics, the reliability of the navigation data is crucial. The navigation systems must then meet some requirements in terms of integrity. For example, the navigation system must be able to determine the position of the mobile with a given integrity risk, that is to say with a defined probability (in particular very low probability, for example 10⁻⁷) that the position error is greater than a radius of protection (i.e. an alert terminal) without any alert being raised. For a satellite navigation system, the failure of a satellite leads to an alteration of the pseudo-range associated with it, which may take the form of a slant, a drift or an acceleration, which induces significant position errors that may increase over time. To guarantee the integrity of the navigation system, it is therefore necessary to be able to detect a satellite failure and, if necessary, to identify the faulty satellite to no longer use the pseudo-ranges associated with it.

In the current state of the art, some solutions use a plurality of Kalman filters to detect a satellite failure and identify the faulty satellite. Each filter excludes the pseudo-ranges associated with one of the satellites so that the pseudo-ranges used are different from one filter to another. For each filter, a statistical indicator is evaluated from the cross-innovation of the filter. By using the statistical indicators of the different filters, it is then possible to detect a satellite failure and to identify the faulty satellite. Such a solution is for example presented in document FR2964468A1. However, for some geometric configurations of the satellites, these solutions may exclude a functional (i.e., non-faulty) satellite instead of the faulty one. Such an exclusion error can in particular lead to a loss of integrity, or to a loss of availability of the navigation system, and must be avoided. In addition, these solutions present a high implementation complexity and require significant use of resources (e.g., computing and memory resources, processing time, etc.).

Moreover, existing RAIM (Receiver Autonomous Integrity Monitoring) solutions allow identifying a faulty satellite without using Kalman filters. These solutions exploit a least-squares algorithm to determine the position of the mobile from the pseudo-ranges associated with the different satellites. Document U.S. Ser. No. 10/684,375B2 illustrates such a solution. To detect a satellite failure, these solutions compare a statistics of the residuals with a threshold, that is to say they use the deviations between the pseudo-ranges provided by the GNSS receiver and the pseudo-ranges calculated from the position of the mobile estimated by the least-squares algorithm. When a satellite failure is detected, the faulty satellite is identified from the amplitude of the residuals, in particular the faulty satellite corresponds to the satellite for which the residual is maximum. However, these solutions may erroneously exclude a functional satellite.

There is therefore a need for a solution that allows reliably identifying a faulty satellite among a set of satellites from pseudo-ranges between a mobile and the different satellites.

### DISCLOSURE OF THE INVENTION

The present invention aims to overcome all or part of the drawbacks of the prior art, in particular those set out above.

According to one aspect of the invention, a method is proposed for identifying a faulty satellite among a set of satellites S₁, . . . , S_{N} from pseudo-ranges between a mobile and the satellites S₁, . . . S_{N}, the method comprising, following a detection of a satellite failure, steps of:
for each satellite Sᵢ of the set of satellites S₁, . . . S_{N}:
   obtaining a set Pᵢ of positions of the mobile, each position p_{i,j} of the set Pᵢ being determined from the pseudo-ranges associated with the satellites S₁, . . . , S_{N} by excluding: the satellite Sᵢ; and at least one other different satellite Sⱼ for each position p_{i,j};
   determining a dispersion indicator ai for the positions of the set Pᵢ; and
identifying the faulty satellite among the set of satellites S₁, . . . , S_{N} as a function of the dispersion indicators σ₁, . . . , σ_{N}.

The present invention proposes, following the detection of a satellite failure, to identify the faulty satellite (denoted Sₓ hereinafter) by using the pseudo-ranges provided by a satellite positioning receiver.

More specifically, for each satellite Sᵢ of a set of satellites S₁, . . . , S_{N}, a set Pᵢ of positions of the mobile is obtained. Each position p_{i,j} of the set Pᵢ is estimated by using the pseudo-ranges associated with the satellites S₁, . . . , S_{N} with the exception of those associated with the satellite Sᵢ and with another satellite Sⱼ (i≠j). In other words, the positions of the set Pᵢ are estimated by using different combinations of satellites among the satellites S₁, . . . , S_{N}, all these combinations excluding the satellite Sᵢ. Two cases must then be distinguished depending on whether the excluded satellite Sᵢ is the faulty satellite Sₓ or a functional satellite.

If the excluded satellite Sᵢ is the faulty satellite Sₓ, then the positions of the set Pₓ are obtained by excluding the pseudo-range associated with the faulty satellite Sₓ. The positions of the set Pₓ are estimated by using only pseudo-ranges associated with functional satellites. Since the faulty satellite Sₓ is not used to determine the positions of the set Pₓ, these positions are sound (i.e. reliable) and have low dispersion (i.e. low variability).

On the other hand, if the excluded satellite Sᵢ is a functional satellite (i≠x), the positions of the set Pᵢ are obtained by using the pseudo-range associated with the faulty satellite Sₓ, with the exception of the position p_{i,x}. Since the faulty satellite Sₓ is used to determine the positions of the set Pᵢ (except the position p_{i,x}), these positions are faulty (i.e. unreliable) and have high dispersion (i.e. high variability). Also, only the position p_{i,x} is sound, while the other positions in the set Pᵢ are faulty.

The present invention proposes to use the dispersion indicators σ₁, . . . , σ_{N} to identify the faulty satellite Sₓ among the set of satellites S₁, . . . , S_{N}. The indicators σ₁, . . . , σ_{N} respectively characterize the dispersion (i.e., the variability) of the positions of the sets P₁, . . . , P_{N}.

Particularly, the identified faulty satellite Sₓ corresponds to the satellite of the set of satellites S₁, . . . , S_{N} for which the dispersion indicator σₓ is minimum. Indeed, the dispersion indicator σₓ, determined by excluding the faulty satellite Sₓ, is representative of a low dispersion of the positions of the set Pₓ. Conversely, the other dispersion indicators σᵢ(i≠x), determined by excluding a functional satellite Sᵢ, are representative of high dispersions.

Thus, the present invention allows reliably identifying a faulty satellite among a set of satellites from the pseudo-ranges between a mobile and the different satellites.

Compared to the existing solutions described above, it should be noted that the present invention allows more reliably and more quickly identifying a faulty satellite. Particularly, the proposed solution has minimal implementation complexity and requires less use of resources (e.g., computing and memory resources, processing time, etc.).

According to one embodiment, the step of determining the dispersion indicator ai comprises steps of:
determining an average position j from the positions of the set Pᵢ;
determining a set Dᵢ of distances between the positions of the set Pᵢ and the average position p̅ᵢ and
determining the dispersion indicator σᵢ from the set Dᵢ, the dispersion indicator σᵢ being equal to a standard deviation of the distances of the set Dᵢ.

In this embodiment, it is proposed to exploit the standard deviation of the distances to the average position as a dispersion indicator σᵢ for the positions of the set Pᵢ. This embodiment allows accurately measuring the dispersion of the positions of the set Pᵢ and requires few computing and memory resources. It thus contributes to providing a solution that allows reliably identifying a faulty satellite among a set of satellites, and with minimal implementation complexity.

According to one embodiment, each set of positions Pᵢ comprises N−1 positions of the mobile, and each position p_{i,j} of the set Pᵢ is determined from the pseudo-ranges associated with the satellites S₁, . . . , S_{N} by excluding: the satellite Sᵢ; and another different satellite Sⱼ for each position p_{i,j}.

According to this embodiment, the positions of a set Pᵢ are determined by using all the possible combinations of N−2 satellites among the satellites S₁, . . . , S_{N} and by excluding the satellite Sᵢ. The set Pᵢ therefore comprises the maximum number of positions determined from N−2 satellites by excluding the satellite Sᵢ for each of the positions.

More specifically, the set Pₓ here comprises N−1 sound (i.e. reliable) positions determined by excluding the faulty satellite Sₓ. The other sets Pᵢ with i≠x comprise respectively: N−2 faulty (i.e. unreliable) positions determined by using the faulty satellite Sₓ; and a single sound position p_{i,x} determined by excluding the faulty satellite Sₓ.

This embodiment allows obtaining a significant deviation between: the dispersion indicator σₓ determined by excluding the faulty satellite Sₓ; and the other dispersion indicators σᵢ(i≠x) determined by using the faulty satellite Sₓ. In this way, this embodiment allows improving the reliability of the proposed solution to identify a faulty satellite Sₓ among a set of satellites S₁, . . . , S_{N}.

According to one embodiment, the method comprises for each satellite Sᵢ of the set of satellites S₁, . . . , S_{N}, and for each satellite Sⱼ of the set of satellites S₁, . . . , S_{N} with j>i: a determination of a position of the mobile from the pseudo-ranges associated with the satellites S₁, . . . , S_{N} by excluding the satellite Sᵢ and the satellite Sⱼ, the determined position being used to obtain the position p_{i,j} of the set Pᵢ and the position p_{j,i} of the set Pⱼ.

To describe this embodiment, consider the position p_{i,j} of the set Pᵢ. This position p_{i,j} is determined from the pseudo-ranges associated with the satellites S₁, . . . , S_{N}, by excluding the satellites Sᵢ and Sⱼ. This is also the case for the position p_{j,i} of the set Pⱼ, so that the positions p_{i,j} and p_{j,i} are identical. In other words, the position p_{i,j} of the set Pᵢ and the position p_{j,i} of the set Pⱼ are both obtained by using the same combination of satellites. This embodiment then proposes to determine the position p_{i,j} and use it for both the set Pᵢ and the set Pⱼ.

According to this embodiment, a position common to several sets among P₁, . . . , P_{N} is determined only once. This embodiment thus allows minimizing the necessary computing and memory resources. It contributes to providing a solution that allows identifying a faulty satellite with a low implementation complexity.

According to one embodiment, the proposed method for identifying a faulty satellite further comprises a step of detecting the satellite failure. More particularly, this step of detecting the satellite failure may comprise each of the steps of a method for detecting a satellite failure in accordance with the invention and described below.

According to one aspect of the invention, a method is proposed for detecting a satellite failure from pseudo-ranges between a mobile and a set of satellites S₁, . . . , S_{N}, the method comprising a step of detecting the satellite failure comprising steps of:
obtaining a set P of positions of the mobile, each position pᵢ of the set P being determined from the pseudo-ranges associated with the satellites S₁, . . . , S_{N} by excluding a different satellite Sᵢ for each position pᵢ;
determining a dispersion indicator σ for the positions of the set P; and
detecting the satellite failure as a function of the dispersion indicator σ.

The present invention proposes to detect a satellite failure by using the pseudo-ranges provided by a satellite positioning receiver.

To do so, it is proposed to obtain a set P of positions of the mobile by using different combinations of satellites among the satellites S₁, . . . , S_{N}. More specifically, each position pᵢ of the set P is estimated by using the pseudo-ranges associated with the satellites S₁, . . . S_{N} with the exception of the one associated with the satellite Sᵢ.

If all the satellites S₁, . . . S_{N} are functional, the positions of the set P are determined by using only pseudo-ranges associated with functional satellites. The positions of the set P are therefore sound (i.e. reliable) and have a low dispersion.

On the other hand, if a satellite Sₓ among the set of satellites S₁, . . . , S_{N} is faulty, only the position pₓ is sound since it is determined by using only pseudo-ranges associated with functional satellites. The other positions pᵢ (i≠x) of the set P are determined by using the pseudo-range associated with the faulty satellite Sₓ, and are therefore faulty. For this reason, in the event of a satellite failure, the positions of the set P have a high dispersion.

To detect a satellite failure, the present invention thus proposes to use the indicator σ characterizing the dispersion of the positions of the set P. Particularly, a satellite failure is detected at least as a function of a comparison of the dispersion indicator σ with a threshold.

Thus, the present invention allows reliably detecting a satellite failure from the pseudo-ranges between a mobile and a set of satellites.

Furthermore, the proposed solution allows detecting a satellite failure more reliably and more quickly than the existing solutions. In particular, the proposed solution has low implementation complexity.

According to one embodiment, the step of determining the dispersion indicator σ comprises steps of:
determining an average position p̅ from the positions of the set P;
determining a set D of distances between the positions of the set P and the average position p̅; and
determining the dispersion indicator σ from the set D, the dispersion indicator σ being equal to a standard deviation of the distances of the set D.

According to this embodiment, the standard deviation of the distances to the average position is used as a dispersion indicator σ for the positions of the set P. This embodiment allows accurately measuring the dispersion of the positions of the set P and requires few computing and memory resources. This embodiment thus contributes to detecting a satellite failure reliably and with minimal implementation complexity.

According to one embodiment, several iterations k₁, . . . , k_{M} of the detection step are implemented for pseudo-ranges acquired at different instants. Furthermore, in this embodiment, the satellite failure is detected during the iteration k_{M} if:
the dispersion indicator σ of the iteration k_{M} is above a threshold; and if
a variation Δσ of the dispersion indicator σ during iterations k₁, . . . , k_{M} is above another threshold.

The failure of a satellite Sₓ results in an alteration of the pseudo-range associated with it, which may take the form of a slant (i.e., a step), a drift (i.e., a ramp) or an acceleration. As a result, the positions of the mobile determined from this pseudo-range will exhibit, over time, a sudden variation or a gradual drift. By using the variation Δσ, in addition to the dispersion indicator σ, this embodiment allows improving the reliability of the detection of a satellite failure.

According to one embodiment, the positions of the mobile are determined by using a Bancroft algorithm.

This embodiment is advantageous in that it allows accurately and quickly determining the position of the mobile from the pseudo-ranges associated with the satellites. Particularly, compared to a Kalman filter, the Bancroft algorithm has low implementation complexity.

It should be noted that the Bancroft algorithm can be used: during the detection of a satellite failure, to determine the positions pᵢ of the set P; and/or during the identification of a faulty satellite, to determine the positions p_{i,j} of the sets Pᵢ.

According to one aspect of the invention, a device is proposed for identifying a faulty satellite among a set of satellites S₁, . . . , S_{N} from pseudo-ranges between a mobile and the satellites S₁, . . . , S_{N}, the device comprising an identification module configured, following a detection of a satellite failure, to:
for each satellite Sᵢ of the set of satellites S₁, . . . , S_{N}:
   obtain a set Pᵢ of positions of the mobile, each position p_{i,j} being determined from the pseudo-ranges associated with the satellites S₁, . . . , S_{N} by excluding: the satellite Sᵢ and; at least one other different satellite Sⱼ for each position p_{i,j};
   determine a dispersion indicator σᵢ for the positions of the set Pᵢ; and
identify the faulty satellite among the set of satellites S₁, . . . , S_{N} as a function of the dispersion indicators σ₁, . . . , σ_{N}.

The device for identifying a faulty satellite may be configured to implement any of the embodiments of a method in accordance with the invention. Particularly, this identification module may be configured to implement each of the steps of a method in accordance with the invention.

According to one embodiment, the proposed device for identifying a faulty satellite further comprises a module for detecting a satellite failure. Particularly, this detection module may be configured to implement each of the steps of a method for detecting a satellite failure in accordance with the invention.

According to one aspect of the invention, a device is proposed for detecting a satellite failure from pseudo-ranges between a mobile and a set of satellites S₁, . . . , S_{N}, the device comprising a detection module configured to:
obtain a set P of positions of the mobile, each position pᵢ of the set P being determined from the pseudo-ranges associated with the satellites S₁, . . . S_{N} by excluding a different satellite Sᵢ for each position pᵢ;
determine a dispersion indicator σ for the positions of the set P; and
detect the satellite failure as a function of the dispersion indicator σ.

The device for detecting a satellite failure may be configured to implement any of the embodiments of a method in accordance with the invention. Particularly, for each step of a method in accordance with the invention, the proposed device for detecting a satellite failure may be configured to implement said step.

According to another aspect of the invention, a navigation system intended to be embedded in a mobile is proposed, comprising:
a satellite positioning receiver configured to provide pseudo-ranges between a mobile and a set of satellites; and
a device for detecting a satellite failure in accordance with the invention and/or a device for identifying a faulty satellite in accordance with the invention.

The navigation system may also comprise a navigation device configured to determine navigation data of the mobile from: pseudo-ranges provided by the satellite positioning receiver; and data derived from an inertial unit.

The proposed navigation system may for example be embedded in an aircraft, a ship or a land vehicle.

According to one aspect of the invention, a mobile machine is proposed comprising a navigation system in accordance with the invention.

According to one embodiment, the mobile machine is an aircraft. As a variant, the mobile machine may be a ship or a land vehicle.

According to one aspect of the invention, a computer program is proposed comprising instructions for implementing the steps of a method in accordance with the invention, when the computer program is executed by at least a processor or a computer.

The computer program may be formed from one or more subparts stored in the same memory or in distinct memories. The program may use any programming language, and may be in the form of source code, object code or intermediate code between source code and object code, such as in a partially compiled form or in any other desirable form.

According to one aspect of the invention, a computer-readable information medium is proposed comprising a computer program in accordance with the invention.

The information medium may be any entity or device capable of storing the program. For example, the medium may include a storage means such as a non-volatile memory or ROM, for example a CD-ROM or a microelectronic circuit ROM, or a magnetic recording means, for example a floppy disk or a hard disk.

Furthermore, the storage medium may be a transmissible medium such as an electrical or optical signal, which may be conveyed via an electrical or optical cable, by radio or by a telecommunications network or by a computer network or by other means. The program according to the invention may particularly be downloaded onto a computer network. Alternatively, the information medium may be an integrated circuit in which the program is incorporated, the circuit being adapted to execute or to be used in the execution of the method in question.

The device for identifying a faulty satellite, the navigation system, the aircraft, the computer program and the information medium proposed have the advantages described above in connection with the proposed identification method.

### BRIEF DESCRIPTION OF THE DRAWINGS

Other characteristics and advantages of the present invention will emerge from the description provided below, illustrating embodiments of the invention given by way of example and without any limitation, with reference to the attached drawings:

FIG. 1 represents the hardware architecture of an aircraft according to one embodiment of the invention;

FIG. 2 represents the functional architecture of a device according to one embodiment of the invention comprising a module for detecting a satellite failure and a module for identifying a faulty satellite;

FIG. 3 represents steps of a method according to one embodiment of the invention for detecting a satellite failure and identifying a faulty satellite;

FIG. 4 represents steps of a method according to one embodiment of the invention for detecting a satellite failure;

FIG. 5 represents values of a dispersion indicator σ determined by a method according to one embodiment of the invention for detecting a satellite failure;

FIG. 6 represents steps of a method according to one embodiment of the invention for identifying a faulty satellite; and

FIG. 7 represents values of dispersion indicators σ₁, . . . , σ_{N} determined by a method according to one embodiment of the invention for identifying a faulty satellite.

### DESCRIPTION OF THE EMBODIMENTS

The present invention applies, particularly, to the satellite navigation systems for aircrafts. The following description of the invention will refer to this particular context of application, which is given only as an illustrative example and should not limit the invention. The latter applies to the satellite navigation for any type of carrier, mobile machine or vehicle.

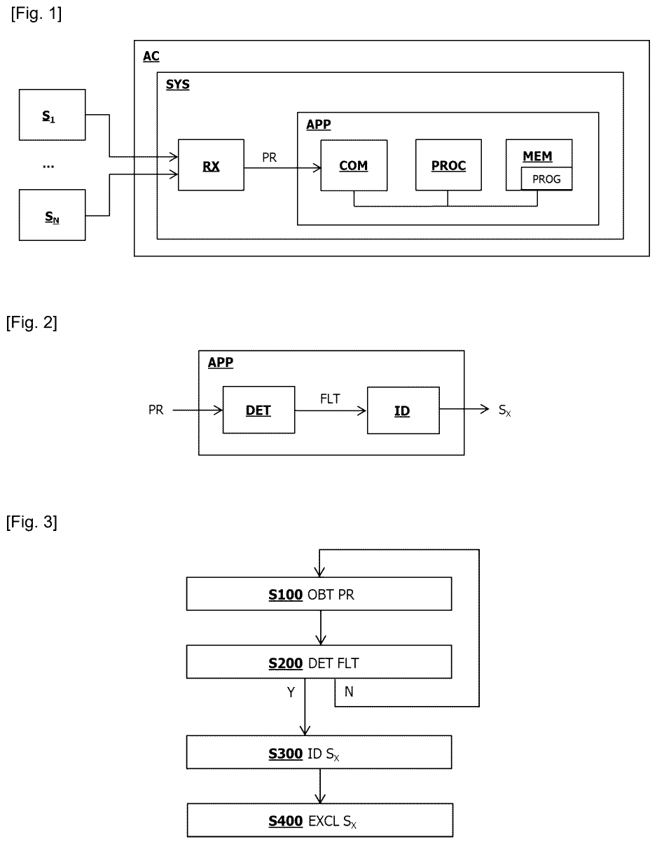

FIG. 1 represents the hardware architecture of an aircraft according to one embodiment of the invention. Particularly, FIG. 1 is described below to introduce the present invention and exemplify a context of application thereof.

The aircraft AC illustrated in FIG. 1 is equipped with a navigation system SYS.

In the context of the invention, the term aircraft designates any device capable of rising and moving in the air, such as an airplane, a helicopter, a drone, etc.

The navigation system SYS comprises a satellite positioning receiver RX (i.e. a GNSS receiver); and a device APP.

The receiver RX is configured to receive signals emitted by the satellites S₁, . . . , S_{N}. The satellites S₁, . . . , S_{N} belong for example to the satellite constellation of the GPS system or of the Galileo system. Furthermore, the receiver RX is configured to determine, from the signals received from the satellites S₁, . . . , S_{N}, the pseudo-ranges PR between the receiver RX of the aircraft AC and the satellites S₁, . . . , S_{N}. The receiver RX provides these pseudo-ranges to the device APP. The “pseudo-range between the aircraft and a satellite” is also referred to as pseudo-range between the receiver RX of the aircraft AC and a satellite Sᵢ.

For a given acquisition instant, and for each satellite Sᵢ among the set of satellites S₁, . . . , S_{N}, the receiver RX provides the pseudo-range prᵢ between the receiver RX and the satellite Sᵢ. Hereinafter PR={pr₁, . . . , pr_{N}} refers to the set of pseudo-ranges PR associated with the satellites S₁, . . . , S_{N}, and acquired at a given instant. Particularly, the number of satellites N is greater than or equal to 6.

The navigation system APP is configured to determine navigation data of the aircraft AC from the pseudo-ranges PR provided by the receiver RX. By “navigation data”, it is meant here data relating to the position and/or to the movement of the aircraft AC, such as geographic coordinates (e.g. latitude, longitude, altitude), the speed, the attitudes.

Furthermore, the navigation system SYS may comprise an inertial unit and implement a hybrid inertial-GNSS navigation. In other words, the navigation system SYS may determine the navigation data of the aircraft AC by using both the pseudo-ranges PR provided by the receiver RX; and the data derived from an inertial unit.

The device APP is configured to: detect a satellite failure; and/or identify a faulty satellite from the pseudo-ranges PR provided by the receiver RX.

In addition, the device APP may be configured to implement the navigation solution of the system SYS, that is to say it may be configured to determine the navigation data of the aircraft AC. However, within the framework of the invention, the navigation solution of the system SYS could also be implemented by another device (distinct from the device APP).

The device APP comprises, according to the embodiment illustrated in FIG. 1: at least one processing unit or processor PROC; and at least one memory MEM.

More particularly, the device APP has, according to one embodiment, the hardware architecture of a computer. The memory MEM constitutes an information medium in accordance with the invention, readable by a computer and by the processor PROC, on which a computer program PROG in accordance with the invention is recorded. The program PROG includes instructions for carrying out steps of a method in accordance with the invention, when the program PROG is executed by the processor PROC. The program PROG defines the functional modules represented in FIG. 2 of the device APP, which rely on or control the hardware elements of the latter.

As illustrated in FIG. 1, the device APP has a communication module COM configured to communicate with the receiver RX. No limitation is attached to the nature of the communication interfaces between these devices, which may be wired or non-wired, and may implement any protocol known to those skilled in the art.

The architecture of the device APP having been introduced, its operation will be described below with reference to the following figures.

FIG. 2 and FIG. 3 respectively represent the functional architecture of a device according to one embodiment of the invention and steps of a method according to one embodiment of the invention.

As illustrated in FIG. 2, the device APP comprises: a module DET for detecting a satellite failure; and/or a module ID for identifying a faulty satellite. The operation of these modules is described below with reference to the steps in FIG. 3.

The term module may correspond to a software component, a hardware component, or a set of hardware and software components. A software component itself corresponds to one or more computer programs or any element of a program able to implement a function or a set of functions. Similarly, a hardware component corresponds to any element of a hardware set able to implement a function or a set of functions.

As illustrated in FIG. 3, the proposed method comprises (all or part of) steps S100 to S400 described below and implemented by the device APP to detect a satellite failure FLT and/or identify a faulty satellite Sₓ.

Note that the proposed method may comprise a plurality of iterations of each of its steps. The steps of the method may be repeated at a given frequency, for example every second.

In step S100, the device APP obtains the pseudo-ranges PR associated with the satellites S₁, . . . S_{N} provided by the satellite positioning receiver RX.

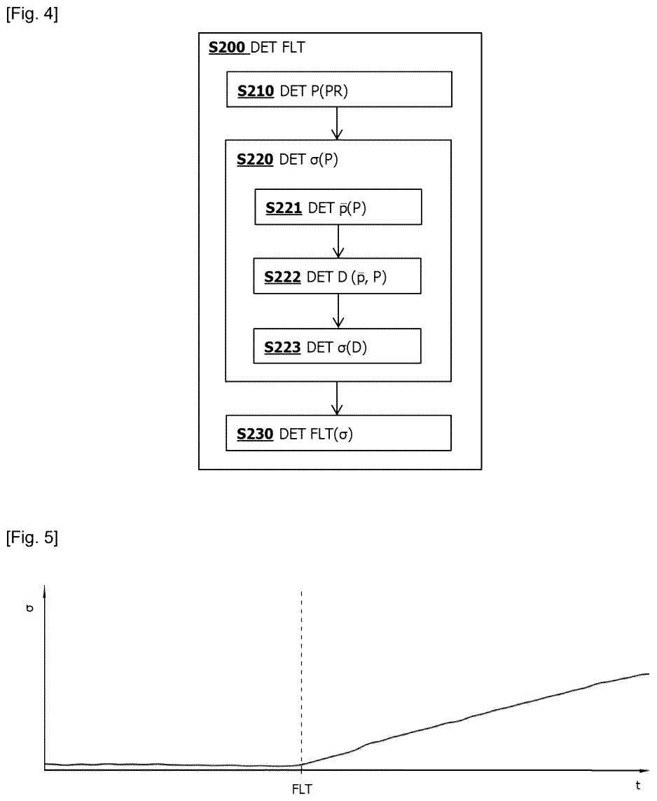

In step S200, the detection module DET of the device APP detects whether or not there is a satellite failure FLT from the pseudo-ranges PR between the receiver RX and the satellites S₁, . . . , S_{N}. The implementation of step S200 is described in more detail with reference to FIG. 4.

If a satellite failure FLT is detected in step S200, then the method continues to step S300; otherwise, the method repeats steps S100 and S200.

Thus, according to one embodiment, the proposed method comprises several iterations k₁, . . . , k_{M} of the detection step S200. The iterations k₁, . . . , k_{M} of this step are implemented for pseudo-ranges PR respectively acquired at instants t₁, . . . , t_{M}.

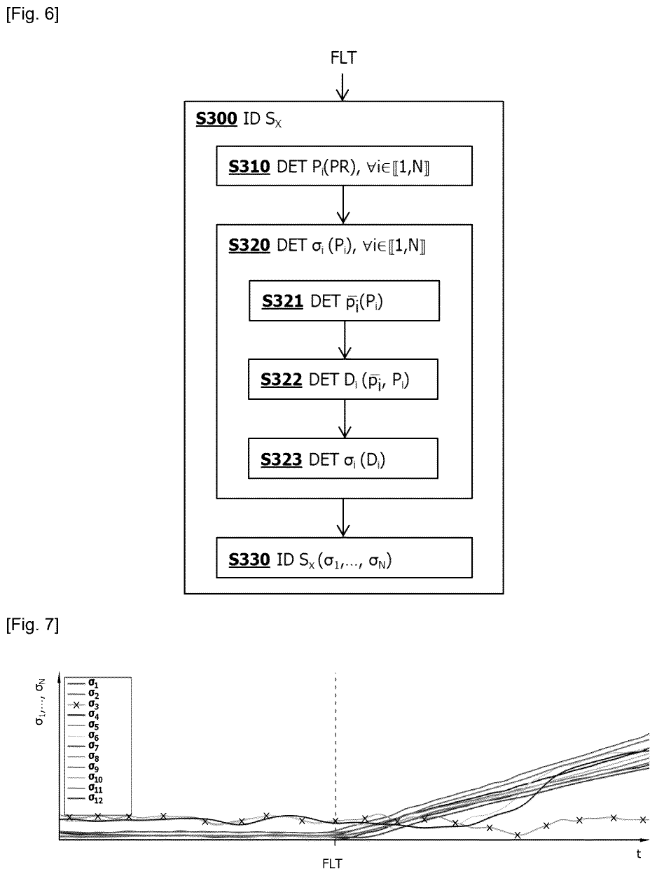

In step S300, following the detection of a satellite failure FLT, the identification module ID of the device APP identifies the faulty satellite Sₓ among the set of satellites S₁, . . . S_{N} from the pseudo-ranges PR between the receiver RX and the satellites S₁, . . . S_{N}. The implementation of step S300 is described in more detail with reference to FIG. 6.

In step S400, the device APP excludes the satellite Sₓ identified as faulty. More specifically, the pseudo-ranges prₓ associated with the satellite Sₓ will no longer be used by the navigation system SYS to determine the navigation data of the aircraft AC.

The proposed solution described here allows detecting a satellite failure FLT and identifying the faulty satellite Sₓ among the set of satellites S₁, . . . , S_{N}. Thus, the proposed method and device APP allow excluding the faulty satellite Sₓ so that the navigation system SYS no longer exploits the pseudo-ranges prₓ associated with it.

It is important to emphasize that the device APP uses only the pseudo-ranges PR provided by the satellite positioning receiver RX (i.e. GNSS data), that is to say it does not use data derived from an inertial unit. Advantageously, the proposed solution can be implemented independently of the navigation solution used by the system SYS.

FIG. 4 represents steps of a method according to one embodiment of the invention. More specifically, this figure details the implementation of step S200 for detecting a satellite failure FLT, previously introduced with reference to FIG. 3.

According to the embodiment illustrated in FIG. 4, the step S200 of detecting a satellite failure FLT comprises the steps S210 to S230 described below.

In step S210, the device APP obtains a set P of positions of the aircraft AC. The set P comprises N positions p₁, . . . , p_{N}. Each position pᵢ of the set P is determined from the set of pseudo-ranges PRᵢ={pr₁, . . . , pr_{N}}prᵢ. In other words, the position pᵢ is resolved by excluding the satellite Sᵢ. More specifically, “position of the aircraft” refers to a position of the receiver RX on board the aircraft AC.

According to one embodiment, the positions p₁, . . . , p_{N} of the set P are respectively determined by using a Bancroft algorithm, for example by using N Bancroft algorithms in parallel. The details of implementation of a Bancroft algorithm, to resolve the position of a mobile from pseudo-ranges associated with a set of satellites, are for example presented in the following document: S. Bancroft, “An Algebraic Solution of the GPS Equations”, IEEE Transactions on Aerospace and Electronic Systems, January 1985.

However, within the framework of the invention, embodiments could also be envisaged in which other algorithms are used to resolve the positions of the aircraft AC, for example a least-squares algorithm or a Kalman filter.

Note that, in some exceptional cases, a Bancroft algorithm may fail to resolve a position pᵢ of the aircraft AC. If this is the case, then the implementation of step S200 of detecting a satellite failure is interrupted, and the method can resume at step S100.

In step S220, the device APP determines a dispersion indicator σ for the positions of the set P. The dispersion indicator σ measures the variability of the positions of the set P.

To this end, and according to the embodiment of FIG. 4, step S220 comprises the steps S221 to S223 described below.

In step S221, the device APP determines an average position p̅ from the positions of the set P. Particularly, the average position

$$\overline{p} = \frac{1}{N} {\sum }_{i} {p}_{i} .$$

In step S222, the device APP determines a set D of distances between the positions of the set P and the average position p̅. Specifically, the set of distances D={d₁, . . . d_{N}} with the distance dᵢ=∥pᵢ−p̅∥.

In step S223, the device APP determines the dispersion indicator σ from the set D of distances. Particularly, the dispersion indicator σ is equal to a standard deviation of the distances of the set D, that is to say

$${σ}^{2} = \frac{1}{N} {\sum }_{i} {( {d}_{i} - \frac{1}{N} {\sum }_{u} {d}_{u} )}^{2} .$$

Within the framework of the invention, embodiments could also be envisaged in which other dispersion indicators a are used to measure the variability of the positions of the set P. For example, the variance of the positions of the set P could be used.

In step S230, the device APP detects whether there is a satellite failure FLT as a function of the dispersion indicator σ. The device APP can for example detect a satellite failure FLT if the dispersion indicator σ is above a threshold λ_{σ}.

More particularly, the device APP detects, according to one embodiment, a satellite failure FLT in the following manner. The iteration k_{M} of the detection step S200 is considered. In addition to the dispersion indicator α, the device APP determines a variation Δσ of the dispersion indicator σ during the previous iterations k₁, . . . , k_{M}. It then detects a satellite failure FLT if (and only if): the dispersion indicator σ is above a threshold Δ_{σ} and the variation Δσ is above a threshold λ_{Δσ}. The thresholds λ_{σ} and λ_{Δσ} can in particular be set as a function of a given false alarm probability.

The variation Δα is determined from the values of the indicator σ determined during all or part of the iterations k₁, . . . , k_{M}. The variation Δσ can for example correspond to a slope coefficient determined by a linear regression of values of the indicator σ determined during the iterations k₁, . . . , k_{M}. According to other examples, the variation Δσ can correspond to a derivative of the indicator σ over time, or to a difference between values of the indicator σ determined during the iterations k₁, . . . , k_{M}. The calculation of the variation Δσ may also involve filtering operations, for example by using a low-pass filter to eliminate the rapid variations in the indicator σ over time.

The proposed solution allows reliably detecting a satellite failure FLT from the pseudo-ranges PR between the receiver RX and the satellites S₁, . . . , S_{N}. This point will be described in more detail with reference to the following figure.

FIG. 5 represents values of a dispersion indicator σ determined by a method according to one embodiment of the invention for detecting a satellite failure.

This figure illustrates the values of the dispersion indicator σ during the iterations of step S200 of detecting a satellite failure FLT. It therefore illustrates the evolution of the dispersion indicator σ over time.

The instant at which the satellite failure FLT occurs is indicated by a dotted line in this figure. Note that the values of the dispersion indicator σ are relatively low before the satellite failure FLT occurs, and that they then increase over time.

At a given instant, if the satellites S₁, . . . , S_{N} are all functional, then the positions of the set P are determined by using only pseudo-ranges associated with functional satellites and are said to be sound positions. The positions of the set P are therefore relatively close to the actual position of the aircraft AC and show low variability. In this case, the value of the dispersion indicator σ is low.

On the other hand, if one satellite Sₓ among the set of satellites S₁, . . . , S_{N} is faulty, only the position pₓ is sound, since it is determined by using only pseudo-ranges associated with functional satellites. The other positions pᵢ (i≠x) of the set P are determined by using the pseudo-range prₓ associated with the faulty satellite Sₓ and are corrupted by this erroneous pseudo-range prₓ. These positions pᵢ (i≠x) are said to be faulty and move away from the actual position of the aircraft AC. In addition, the faulty positions pᵢ (i≠x) show significant variations therebetween. In the event of a satellite failure FLT, the positions of the set P show a high variability and the value of the dispersion indicator σ is significant.

For this reason, it is in particular proposed to compare the dispersion indicator σ with the threshold Δ_{σ} to detect a satellite failure FLT.

Furthermore, it should be mentioned that the failure of the satellite Sₓ leads to an alteration of the pseudo-range prₓ associated with it over time, which can take the form of a slant, a drift or an acceleration. As a result, the values of the dispersion indicator σ will show, over time, a sudden variation or a gradual increase as illustrated in FIG. 5.

Consequently, by jointly using the dispersion indicator σ and the variation Δσ, the proposed solution allows reliably detecting a satellite failure FLT from pseudo-ranges PR between the receiver RX and the satellites S₁, . . . , S_{N}.

Following the detection of a satellite Sₓ failure, the proposed device APP identifies the faulty satellite Sₓ among the set of satellites S₁, . . . , S_{N}, to then exclude this faulty satellite Sₓ and no longer use the pseudo-ranges associated with it. Step S300 of identifying the faulty satellite Sₓ is described with reference to FIGS. 6 and 7.

FIG. 6 represents steps of a method according to one embodiment of the invention. This figure details the implementation of step S300 of identifying the faulty satellite Sₓ, introduced above with reference to FIG. 3.

According to the embodiment illustrated by FIG. 6, step S300 of identifying the faulty satellite Sₓ comprises steps S310 to S330 described below.

As illustrated in FIG. 6, step S300 of identifying the faulty satellite Sₓ is triggered by the detection of a satellite failure FLT. It is important to emphasize that the proposed method may comprise step S200 of detecting the satellite failure FLT described above.

However, within the framework of the invention, embodiments could also be envisaged in which the satellite failure FLT is detected by another device (distinct from the device APP), which triggers the implementation of the steps described below.

For each satellite Sᵢ of the satellites S₁, . . . , S_{N}, the device APP implements steps S310 and S320. Steps S310-S320 can be implemented in parallel (i.e. concomitantly) for the different satellites S₁, . . . , S_{N}.

In step S310, the device APP obtains a set Pᵢ of positions of the aircraft AC. The set of positions Pᵢ comprises N−1 positions. Each position p_{i,j} of the set Pᵢ is determined from the set of pseudo-ranges PR_{i,j}={pr₁, . . . , pr_{N}}\{prᵢ,prⱼ} with i≠j. In other words, each position p_{i,j} is resolved by excluding: the satellite Sᵢ; and another different satellite Sⱼ for each position p_{i,j}.

According to one embodiment, the positions of the set Pᵢ are respectively determined by using a Bancroft algorithm. However, embodiments in which other algorithms are used to resolve these positions could be envisaged.

The sets P₁, . . . , P_{N} comprise a total of N(N−1) positions. However, it is not necessary to implement N(N−1) Bancroft algorithms. Some positions are common to several sets. For example, the position p_{i,j} of the set Pᵢ and the position p_{j,i} of the set Pⱼ are identical. These two positions are both determined from the pseudo-ranges {pr₁, . . . , pr_{N}}\{prᵢ,prⱼ}, i.e. by excluding the satellites Sᵢ and Sⱼ.

For this reason, according to one embodiment, the device APP obtains the sets of positions P₁, . . . , P_{N} in the following manner. For any i∈[[1,N]], and for any j∈[[1,N]] such that j>i, the device APP resolves a position p_{i,j} of the aircraft AC from the pseudo-ranges {pr₁, . . . , pr_{N}}\{prᵢ,prⱼ}. It then uses the determined position p_{i,j} for both the set Pᵢ and the set Pⱼ. Consequently, the device APP determines only N(N−1)/2 positions of the aircraft AC, for example by using N(N−1)/2 Bancroft algorithms in parallel. This embodiment thus allows minimizing the computing resources required to implement the proposed solution.

Note that, in some exceptional cases, one of the Bancroft algorithms may fail to resolve a position p_{i,j} of the aircraft AC. If this is the case, then the implementation of step S300 of identifying the faulty satellite is interrupted, and the method can resume at step S100.

In step S320, the device APP determines a dispersion indicator σᵢ for the positions of the set Pᵢ. The dispersion indicator σᵢ measures the variability of the positions of the set Pᵢ.

To this end, and according to the embodiment of FIG. 6, step S320 comprises steps S321 to S323 described below.

In step S321, the device APP determines an average position j from the positions of the set Pᵢ. Particularly, the average position

$$\overline{{p}_{i}} = \frac{1}{N - 1} {\sum }_{j = 1 , j \neq i}^{N} {p}_{i , j} .$$

In step S322, the device APP determines a set Dᵢ of distances between the positions of the set Pᵢ and the average position p̅ᵢ. Specifically, for any j∈ [symbol] 1,N [symbol] such that j≠i, the distance d_{i,j} of the set Dᵢ is defined by d_{i,j}=∥p_{i,j}−p̅ᵢ∥.

In step S323, the device APP determines the dispersion indicator σᵢ from the set of distances Dᵢ. The dispersion indicator σᵢ is here equal to a standard deviation of the distances of the set Dᵢ. We therefore have

$${σ}_{i}^{2} = \frac{1}{N - 1} {\sum }_{j = 1 , j \neq i}^{N} {( {d}_{i , j} - \frac{1}{N - 1} {\sum }_{u = 1 , u \neq i}^{N} {d}_{i , u} )}^{2} .$$

Alternatively, embodiments of the invention could be envisaged in which other types of dispersion indicators al are used to measure the variability of the positions of the set Pᵢ.

In step S330, the device APP identifies the faulty satellite Sₓ among the set of satellites S₁, . . . , S_{N} as a function of the dispersion indicators σ₁, . . . , σ_{N}. The faulty satellite Sₓ identified by the device APP corresponds here to the satellite of the set of satellites S₁, . . . , S_{N} for which the dispersion indicator σₓ is minimum, i.e. σₓ=min(σ₁, . . . , σ_{N}).

The proposed solution allows, in the event of a satellite failure, identifying the faulty satellite Sₓ from the pseudo-ranges PR between the receiver RX and the satellites S₁, . . . , S_{N}. The reasons for which the proposed solution allows reliably identifying the faulty satellite Sₓ will be presented with reference to the following figure.

FIG. 7 represents values of dispersion indicators σ₁, . . . , σ_{N} determined by a method according to one embodiment of the invention for identifying a faulty satellite.

This figure illustrates, by way of example, the evolution of the dispersion indicators σ₁, . . . , σ_{N} over time. In this example, the number of satellites N is equal to 12, and the faulty satellite Sₓ is the satellite S₃.

The satellite failure FLT occurs at the instant indicated by dotted lines in the figure. Before the satellite failure FLT occurs, the values of the dispersion indicators σ₁, . . . , σ₁₂ are low. Then, the values of these indicators all increase over time, with the exception of the dispersion indicator σ₃ determined by excluding the faulty satellite S₃.

The dispersion indicator σ₃ is determined by excluding the faulty satellite S₃. More specifically, the positions of the set P₃ are obtained by excluding the pseudo-range prs associated with the faulty satellite S₃. Thus, the positions of the set P₃ are estimated by using only pseudo-ranges associated with functional satellites. Since the faulty satellite S₃ is not used, the positions of the set P₃ are all sound positions and show low variability. The value of the dispersion indicator 03 is therefore low.

Conversely, the other dispersion indicators σᵢ (i≠3) are respectively determined by excluding a functional satellite Sᵢ. The positions of the set Pᵢ are obtained by using the pseudo-range associated with the faulty satellite S₃, with the exception of the position p_{i,3}. The set Pᵢ then comprises 10 (i.e. N−2) faulty positions and a sound position p_{i,3}. For this reason, the positions of the set Pᵢ show a high variability and the value of the dispersion indicator al is significant.

By identifying the satellite Sₓ of the set of satellites S₁, . . . , S_{N} for which the dispersion indicator σₓ is minimum, the proposed solution allows reliably identifying the faulty satellite among the set of satellites S₁, . . . , S_{N}.

Advantageously, the solution proposed above allows detecting a satellite failure and identifying the faulty satellite by using only pseudo-ranges provided by a satellite positioning receiver, that is to say without using inertial data. The proposed solution can in particular be implemented independently of the navigation solution used by the system SYS for the aircraft AC.

Additional variants: It should be noted that the order in which the steps of a method in accordance with the invention follow one another, in particular with reference to the attached drawings, constitutes only one exemplary embodiment without any limitation, variants being possible. Particularly, a method in accordance with the invention may comprise one or more iterations of the steps described above, in particular with reference to the attached drawings. Moreover, the reference signs do not limit the scope of the protection, their sole function being to facilitate the understanding of the claims.

Those skilled in the art will understand that the embodiments and variants described above constitute only non-limiting examples of implementation of the invention. Particularly, those skilled in the art will be able to envisage any adaptation or combination of the embodiments and variants described above in order to meet a very specific need.

1. A method for identifying a faulty satellite among a set of satellites S₁, . . . , S_{N} from pseudo-ranges between a mobile and the satellites S₁, . . . , S_{N}, the method comprising, following a detection of a satellite failure, steps of:
for each satellite Sᵢ of the set of satellites S₁, . . . , S_{N}:
obtaining a set Pᵢ of positions of the mobile, each position p_{i,j} being determined from the pseudo-ranges associated with the satellites S₁, . . . , S_{N} by excluding: the satellite Sᵢ; and at least one other different satellite Sⱼ for each position p_{i,j};
determining a dispersion indicator σᵢ for the positions of the set Pᵢ; and
identifying the faulty satellite among the set of satellites S₁, . . . , S_{N} as a function of the dispersion indicators σ₁, . . . , σ_{N}.

2. The method according to claim 1, wherein the step of determining the dispersion indicator σᵢ comprises steps of:
determining an average position p̅ᵢ from the positions of the set Pᵢ;
determining a set Dᵢ of distances between the positions of the set Pᵢ and the average position p̅ᵢ; and
determining the dispersion indicator σᵢ from the set Dᵢ, the dispersion indicator σᵢ being equal to a standard deviation of the distances of the set Dᵢ.

3. The method according to claim 1, wherein each set of positions Pᵢ comprises N−1 positions of the mobile, and each position p_{i,j} of the set Pᵢ is determined from the pseudo-ranges associated with the satellites S₁, . . . , S_{N}, by excluding: the satellite Sᵢ; and another different satellite Sⱼ for each position p_{i,j}.

4. The method according to claim 3, comprising, for each satellite Sᵢ of the set of satellites S₁, . . . , S_{N}, and for each satellite Sⱼ of the set of satellites S₁, . . . , S_{N} with j>i: a determination of a position of the mobile (AC) from the pseudo-ranges associated with the satellites S₁, . . . , S_{N}, by excluding the satellite Sᵢ and the satellite Sⱼ, the determined position being used to obtain the position p_{i,j} of the set Pᵢ and the position p_{j,i} of the set Pⱼ.

5. The method according to claim 1, further comprising a step of detecting the satellite failure, the detection step comprising steps of:
obtaining a set P of positions of the mobile, each position pᵢ being determined from the pseudo-ranges associated with the satellites S₁, . . . , S_{N} by excluding a different satellite Sᵢ for each position pᵢ;
determining a dispersion indicator σ for the positions of the set P; and
detecting the satellite failure as a function of the dispersion indicator σ.

6. The method according to claim 5, wherein the step of determining the dispersion indicator σ comprises steps of:
determining an average position p̅ from the positions of the set P;
determining a set D of distances between the positions of the set P and the average position p̅; and
determining the dispersion indicator σ from the set D, the dispersion indicator σ being equal to a standard deviation of the distances of the set D.

7. The method according to claim 5, comprising several iterations k₁, . . . , k_{M} of the detection step, the iterations k₁, . . . , k_{M} being implemented for pseudo-ranges acquired at different instants, and wherein the satellite failure is detected during the iteration k_{M} if:
the dispersion indicator σ of the iteration k_{M} is above a threshold; and if:
a variation Δσ of the dispersion indicator σ during iterations k₁, . . . , k_{M} is above another threshold.

8. The method according to claim 8, wherein the positions of the mobile are determined by using a Bancroft algorithm.

9. A device for identifying a faulty satellite among a set of satellites S₁, . . . , S_{N} from pseudo-ranges between a mobile and the satellites S₁, . . . , S_{N}, the device comprising an identification module configured, following a detection of a satellite failure, to:
for each satellite Sᵢ of the set of satellites S₁, . . . , S_{N}:
obtain a set Pᵢ of positions of the mobile, each position p_{i,j} being determined from the pseudo-ranges associated with the satellites S₁, . . . , S_{N} by excluding: the satellite Sᵢ; and at least one other different satellite Sⱼ for each position p_{i,j};
determine a dispersion indicator σᵢ for the positions of the set Pᵢ; and
identify the faulty satellite among the set of satellites S₁, . . . , S_{N} as a function of the dispersion indicators σ₁, . . . , σ_{N}.

10. A navigation system intended to be embedded in a mobile comprising:
a satellite positioning receiver configured to provide pseudo-ranges between the mobile and a set of satellites; and
a device according to claim 9.

11. A mobile machine comprising a navigation system according to claim 10.

12. A computer program comprising instructions for implementing the steps of a method according to claim 1, when said computer program is executed by at least one processor.
